(19) United States
(12) Patent Application Publication
(10) Pub. No.: US 2015/0025847 A1
(43) Pub. Date: Jan. 22, 2015

(54) QUANTITATIVE ELEMENTAL PROFILING IN OPTICAL EMISSION SPECTROSCOPY

(71) Applicant: University of Central Florida Research Foundation, Inc., Orlando, FL (US)

(72) Inventor: Matthieu Baudelet, Orlando, FL (US)

(21) Appl. No.: 14/334,206

(22) Filed: Jul. 17, 2014

Related U.S. Application Data
(60) Provisional application No. 61/847,370, filed on Jul. 17, 2013.

(51) Int. Cl. G01J 3/443; G01N 21/71; G01J 3/02; G01N 21/63

(52) U.S. Cl. CPC G01J 3/443; G01N 21/63; G01N 21/718; G01J 3/0297; G01N 2201/06113; G01N 2201/0697
USPC 702/182

(57) ABSTRACT

The current invention considers the spectrum as a multimodal distribution over a list of structures containing the wavelength as the main entry and the other information mentioned above in the list as additional entries. Each line is then given a probability of contributing to the spectral line. In the case of multiple spectral lines, inference between spectral lines and their respective levels of confidence will provide a complete picture of the list of probable emitters with a probability factor for each line in order to provide a quantitative assignment of the spectral lines and profiling for a given spectrum.

### CROSS-REFERENCE TO RELATED APPLICATIONS

This nonprovisional application is a continuation of and claims priority to provisional application No. 61/847,370, entitled “Quantitative Elemental Profiling in Optical Emission Spectroscopy”, filed Jul. 17, 2013 by the same inventor, the entirety of which is incorporated herein by reference.

### FEDERALLY SPONSORED RESEARCH OR DEVELOPMENT

This invention was made with Government support under Grant No. 201.2DNBXK027 awarded by the National Institute of Justice. The government has certain rights in the invention.

### BACKGROUND OF THE INVENTION

1. Field of the Invention

This invention relates, generally, to spectral analysis. More specifically, it relates to the normalization of line assignments in spectral analysis to accurately determine confidence levels of identity of elements represented by said line assignments.

2. Brief Description of the Prior Art

Spectroscopic techniques based on emission (LIBS, ICP-OES, GD-OES, Arc, Spark, etc.), rely on the assignment of the spectral peaks in a spectrum to know the composition of the material that is analyzed. The assignment of these peaks is done by looking up in a database that usually contains information such as (1) the position of the peak in the spectrum (wavelength, wavenumber, energy, etc.); (2) the origin of the peak (emitter, absorber, vibrational mode, etc.); (3) the strength of the absorption/emission/scattering (Einstein coefficients, cross section, oscillator strength, etc.); and (4) additional technical details on the physics of the transition.

The spectral analysis is typically performed by either a practitioner or an algorithm. However, there is no quantitative evaluation of the quality of this assignment. This evaluation of the level of confidence can be utilized in the ongoing question of accuracy and precision of assignment of a spectral line in the spectrum. What is needed is a technology that establishes such level of confidence.

The conventional art provides only the line assignment without a factor to judge the confidence in this assignment. This lack of a measure of confidence prevents a complete trust in the case of low resolution and forces the user or operator to rely on the experience, training, and skill set of an expert practitioner.

The LIBS technique, contemplated herein as an example of optical emission spectroscopy, provides spectra for the possible identification and classification of compositions, such as pollutants. The use of the spectral lines in the spectrum relies on the assignment of these lines to the emitter at the origin of the emission. This assignment is done by the analyst (either itself or via an algorithm) by looking inside a database for the position of the peak, its emitter and its probability (absolute or relative) of emission. However, conventional LIBS technology relies on low resolution spectra (10 pm), non-adapted databases, dynamic plasma (broadening and shifts of spectral lines [W. Hubert, G. Ankerhold, “Elemental misinterpretation in automated analysis of LIBS spectra”, Analytical and Bloanalytical Chemistry 400(10), 3273-3278 (2011)]), and a lack of protocol (i.e., the specimen type and apparatus used affects the resultant detection limits, and as such, accuracy and precision can change from test to test depending on these factors). There is, thus, a need for a level of confidence in LIBS line assignment—an aspect that the conventional art has not contemplated.

Regarding the low resolution and interference relied upon by LIBS technology, the spectral resolution of the LIBS instrument is typically in the order of 0.01 to 0.05 nm pixel-to-pixel, in order to detect several spectral lines and still remain compact. This means that the spectral resolution is usually 0.03 to 0.15 nm. The MIT wavelength tables [G. R. Harrison, “Massachusetts institute of Technology Wavelength tables” (1969)] establish that for “line-classification purposes”, the wavenumber of a line must be known within 0.02 cm⁻¹ (0.02 pm for an emission at 300 nm). Even with attempts to increase this resolution by data processing [B. O'Leary, J. A. Kelley, “Utilization of the coherence function with Welch's method for signal analysis in low resolution laser-induced breakdown spectroscopy”, Applied Spectroscopy 64(4), 370-376 (2010)], the LIBS instruments then are not suitable for an indisputable line assignment. As a result, spectral interferences are unavoidable. Furthermore, the plasma conditions can involve broadening and shift of the spectral lines.

Typical databases used in optical emission spectroscopy are the MIT [G. R. Harrison, “Massachusetts institute of Technology Wavelength tables” (1969)] and NIST [ASD Data Lines Levels, National Institute of Standards and Technology: Physical Measurement Laboratory, March 1999] spectral databases were established by arc spectrochemical excitation. The Kurucz database, based on an atomic and molecular code, is also used.

Additionally, there is a lack of precision in tables for spectral analysis since analysis is generally qualitative. As warned by NIST itself [ASD Data Lines Levels, National Institute of Standards and Technology: Physical Measurement Laboratory, March 1999], relative intensities are noted by authors of each publication, and thus, there is no common scale for these relative intensities. The different authors provide and use different scales, the relative intensities only have a meaning within the given scale or spectrum (i.e., within the spectrum of a given element in a given stage of ionization). Further, relative intensities are dependent on the light source used for the excitation. Also, the relative intensities are primarily useful for comparing strengths of spectral lines that are not separated widely, since there generally is no correction for spectral sensitivity of the measuring instruments (spectrometers, photomultipliers, photographic emulsions). Furthermore, the majority of these values are based on the MIT wavelength tables [G. R. Harrison, “Massachusetts Institute of Technology Wavelength tables” (1969), page xii], where the author explains how highly non-quantitative their procedure is, where the procedure is based on “eye estimates of the lines made by observing them on a screen”. In the case where the authors did not themselves measure the lines, they “adjusted the intensity values to fit [their] scale as best as [they] could”. It then becomes obvious that a quantitative measure of the level of confidence cannot rely on such relative intensity values.

In the particular case of LIBS, the plasma is dynamic. Since the temperature and density of the plasma change with time, the Stark effect, in particular Stark shift and Stark broadening, evolves in time. This further hinders confidence levels in the assessment of the emitter for spectral analysis [W. Hübert, Ankerhold, “Elemental misinterpretation in automated analysis of LIBS spectra”, Analytical and Bioanalytical chemistry 400(10), 3273-3278 (2011)].

Accordingly, what is needed is a method for accurately determining a level of confidence in line assignment in order to enhance accuracy and precision of assignment of a spectral line in the spectrum. However, in view of the art considered as a whole at the time the present invention was made, it was not obvious to those of ordinary skill in the field of this invention how the shortcomings of the prior art could be overcome.

The current methodology can also rely on additional information, for example information about other spectral lines (towards full spectrum) and quantitative information about a known composition of the sample. Whereas the conventional art provides a qualitative analysis (i.e., a guess), the current invention provides a quantitative analysis (i.e., the level of confidence in the assignment).

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for accurate and precise levels of confidence in spectral line assignments is now met by a new, useful, and nonobvious invention.

It is an object of the current invention to provide users a level of confidence for a line assignment, which, in turn, can provide a quantitative evaluation of the line assignment to non-specialists who want to be aware of eventual spectral interferences for decision making. The invention enables the step of line assignment in the quantitative decision making process.

Applications of the current invention include, but are not limited to, quantitative spectral analysis for forensic purposes, QA/QC, processes needing line assignment (plasma temperature measurements, for example), and line assignments even with low resolution spectral analyzers.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is graphical illustrations depicting typical atomic emission spectrum showing the decomposition of the signal into noise and distributions components. An additional baseline component can be encountered.

FIG. 2 depicts an example spectrum as a multimodal distribution over a list of emitters from a database.

FIG. 3 is graphical illustrations depicting the probability of assignment.

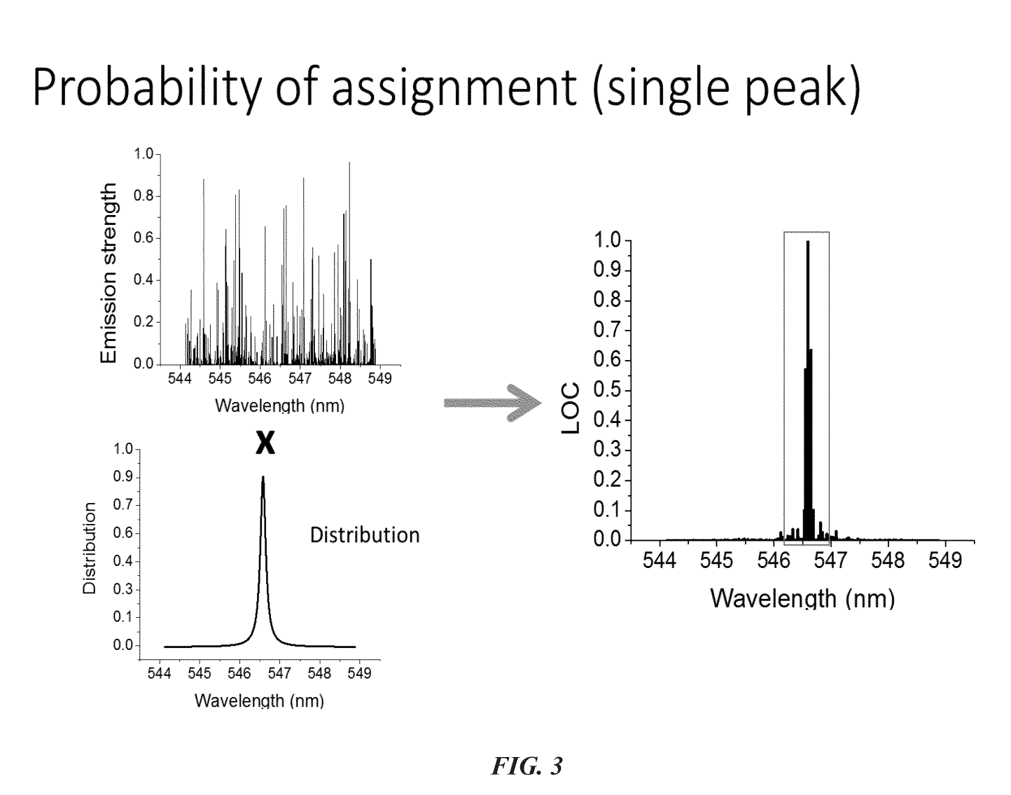

FIG. 4 is a graphical illustration depicting the probability of assignment of each element in the sample analyte.

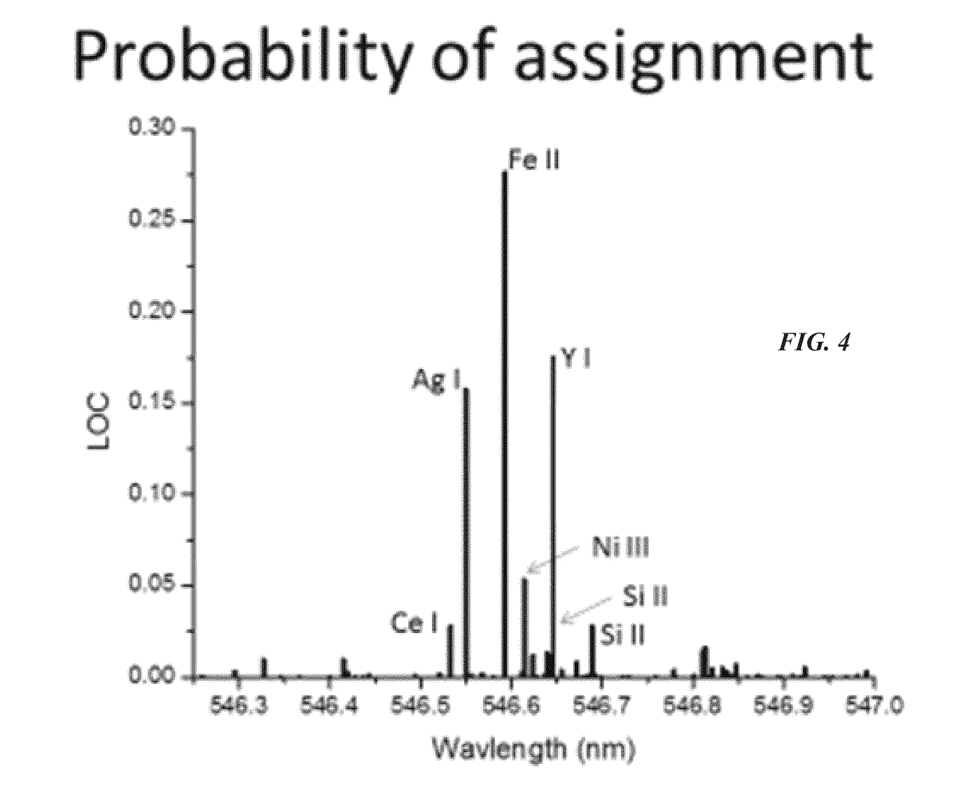

FIG. 5 is a flowchart depicting an exemplary step-by-step algorithm of an embodiment of the current invention.

FIG. 6 is a flowchart depicting the algorithm for the calculation of the levels of confidence in each transition for each spectral peak.

FIG. 7 depicts a transition between two levels |up> and |down>, of respective energy Eᵤₚ and E_{down}, and of probability A. N being the population of the upper level.

FIG. 8 depicts matching score between theoretical spectra of candidate elements and input spectrum.

FIG. 9 is an example of LOC after single peak analysis without correlation measurements.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

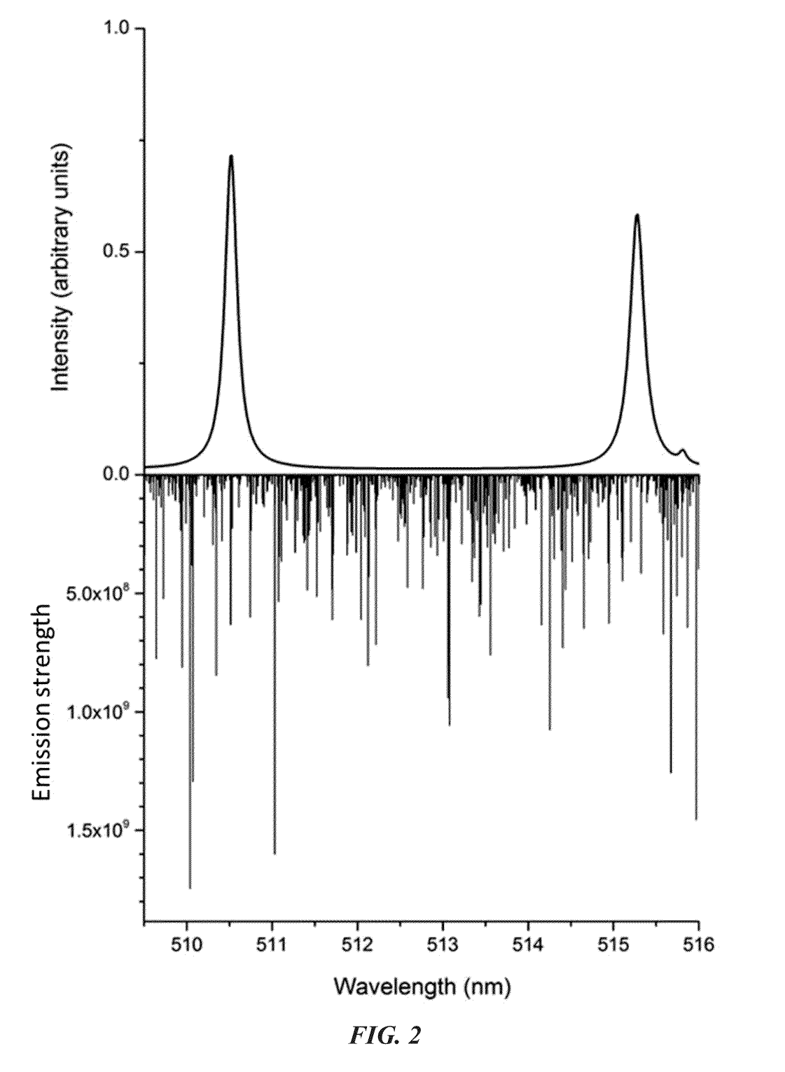

The current invention considers the spectrum as a multimodal probability distribution over a list of structures containing the wavelength as the main entry (an example spectrum can be seen in FIG. 2). Additional entries can include, but are not limited to, (1) the position of the peak in the spectrum (wavelength, wavenumber, energy, etc.); (2) the cause for the peak (emitter, absorber, etc.); (3) the strength of the process (absorption, emission, etc.) (Einstein coefficients, cross section, oscillator strength, etc.); and (4) additional technical details on the physics of the process. Each transition in the database is then given a probability of contributing to the spectral line. In the case of multiple spectral lines in the spectrum, inference between spectral lines and their respective level of confidence would provide a further complete picture of the list of probable emitters with a probability factor for each transition in order to provide a quantitative assignment of the spectral lines and profile for a given spectrum.

The approach developed in this invention does not need to rely on input information on the resolution of the spectral analyzer but uses the spectrum as the input, in addition to eventual prior knowledge of the sample under analysis. The current invention may be a plugin in software or a stand-alone software application that provides an enhanced quantitative analysis factor for spectroscopy.

In an exemplary embodiment, the current invention can be explained with LIBS spectra. However, it is contemplated that a person of ordinary skill in the art would be able to expand and apply the invention to other spectral techniques mentioned previously. The spectrum can be seen as a multimodal probability distribution over a variable that is the wavelength. Each peak in the distribution can be considered as a probability distribution, which will determine which wavelengths appear more probable in the spectrum. Since the distributions are not infinitely sharp, each peak defines a range of wavelengths, each of which are given a probability that is its Y-value of the peak if the spectrum is considered as an X-Y graph (X-being the wavelength value).

The values of the wavelengths that are important are not the ones provided by the spectrum, but the listed ones in the database. As a consequence, the spectrum becomes a multimodal distribution over a list of structures containing the wavelength as the main entry and the other information mentioned previously as additional entries.

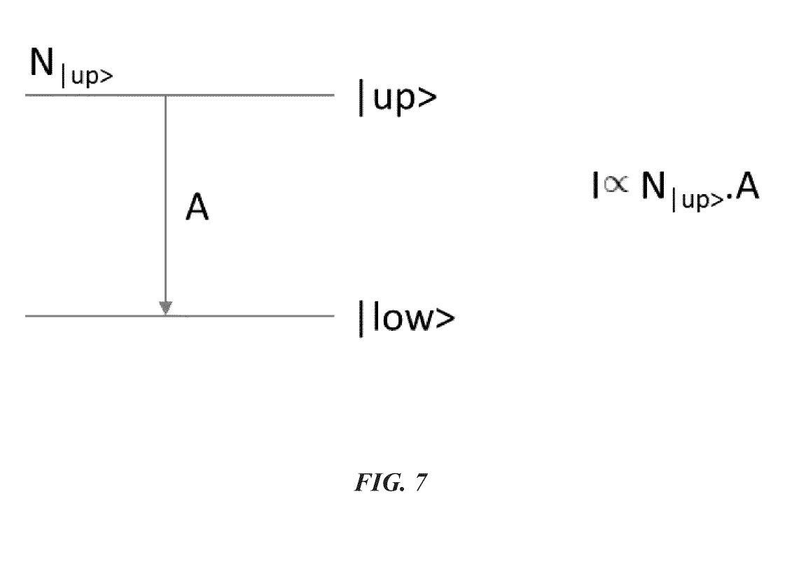

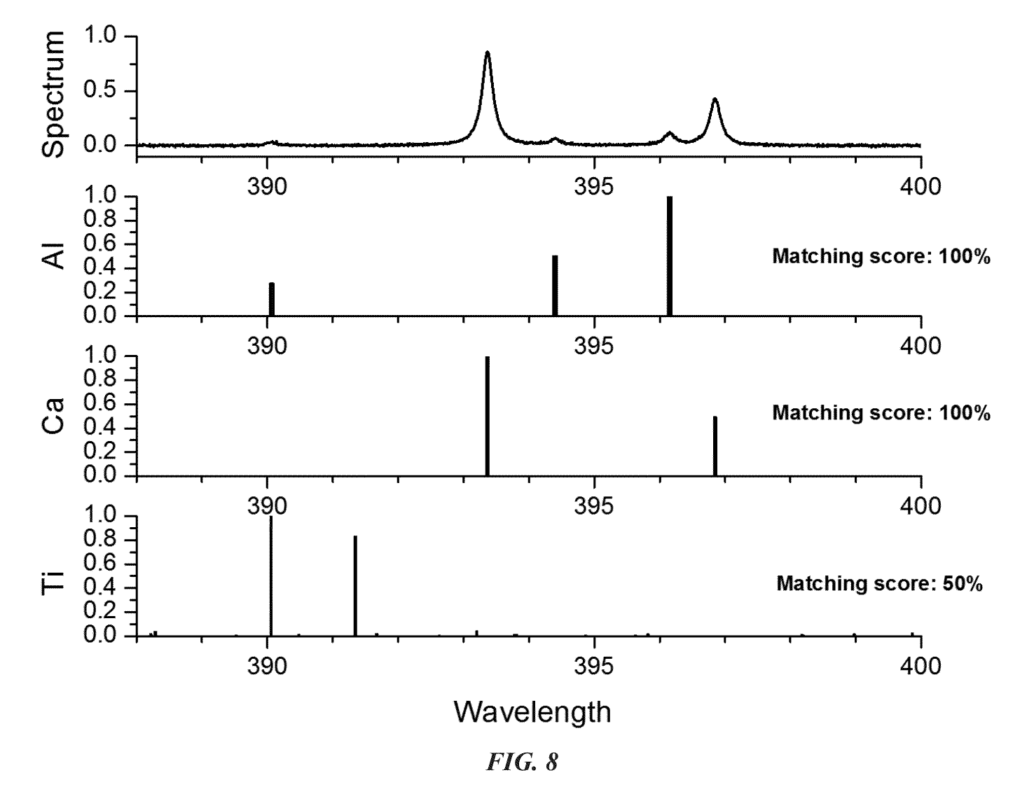

The emission strength, globally represented by Nᵤₚ*A_{up→low} for a transition as in FIG. 8, Nᵤₚ being the population of the upper level and A the probability of transition, can have values that depend on the degree of complexity that the practitioner needs, for example including, but not limited, to the list as follows:
Equiprobability of transition: where each transition has the same value
Known sample composition: each element is represented by its known concentration in the sample
Transition probability value: the probability of transition (given by the Einstein coefficient A, the oscillator strength for a relative intensity tier example)
Upper level population value (see FIG. 7): where the population of the upper level is given by N_{|up>}=N·g·exp(−Eᵤₚ/T)/Z(T) with N the value given to the concentration of the emitter in the plasma, g the degeneracy of the upper level, Eᵤₚ the energy of the upper level, T the temperature given/measured to/in the plasma and Z(T) the partition function of the ion at the temperature T
Modeled value of the upper level population and/or of the probability transition

These different factors can be combined to provide a more precise value of the emission strength.

The calculation of a level of confidence in the assignment of each line in a spectrum relies on the knowledge of “emission strength” for each possible wavelength (transition) in the database. This is mainly based on the physical process giving rise to the peak in the spectrum.

This emission strength can be given or deduced from the database. The number of emitters giving rise to the emission N can be determined at different levels of complexity from equiprobability, to knowing the population of the upper level at the origin of the emission (in plasma based techniques). The differences between the different values of N will influence of the level of confidence and must be stated as the condition for the level of confidence calculation.

Once each database wavelength in the spectral range is given an emission strength weighed by the Y-value of the spectral channel as mentioned above, normalization of each value so their sum equals one (1) over a given spectral range is performed. In this case, the level of confidence is established for each spectral line. In the case of a spectrum with multiple spectral lines, the first step of calculating level of confidence can be done for each line and then inference calculation between spectral lines can be done in order to take into account the knowledge of other lines in the calculation of the level of confidence for each line in the spectrum.

At this point, each spectral line of the spectrum can be given a list of probable emitters with a level of confidence for each of them.

In addition to obtaining a LOC for the assignment of each spectral peak as if they were independent, a correcting term to this “single peak LOC” can be calculated. This correcting term takes into account the dependence of the peaks one to another in the spectrum. Such a term can be calculated before, after (or both) the “single peak LOC” calculation.

The advantages or benefits of certain embodiments of the current invention over the conventional art includes, but is not limited to, increased efficiency, enhanced cost benefit, increased simplicity and the ability to overcome a defeat. The users of such levels of confidence can then provide a quantitative evaluation of their line assignments to non-specialists who want to be aware of eventual spectral interferences for decision-making. It will enable the step of line assignments in the quantitative decision making process.

Possible uses of certain embodiments of the current invention include, but are not limited to, quantitative spectral analysis for court purposes, quality assurance or quality control, processes needing line assignment (plasma temperature measurements for example), and line assignment even with low resolution spectral analyzers.

### EXAMPLE

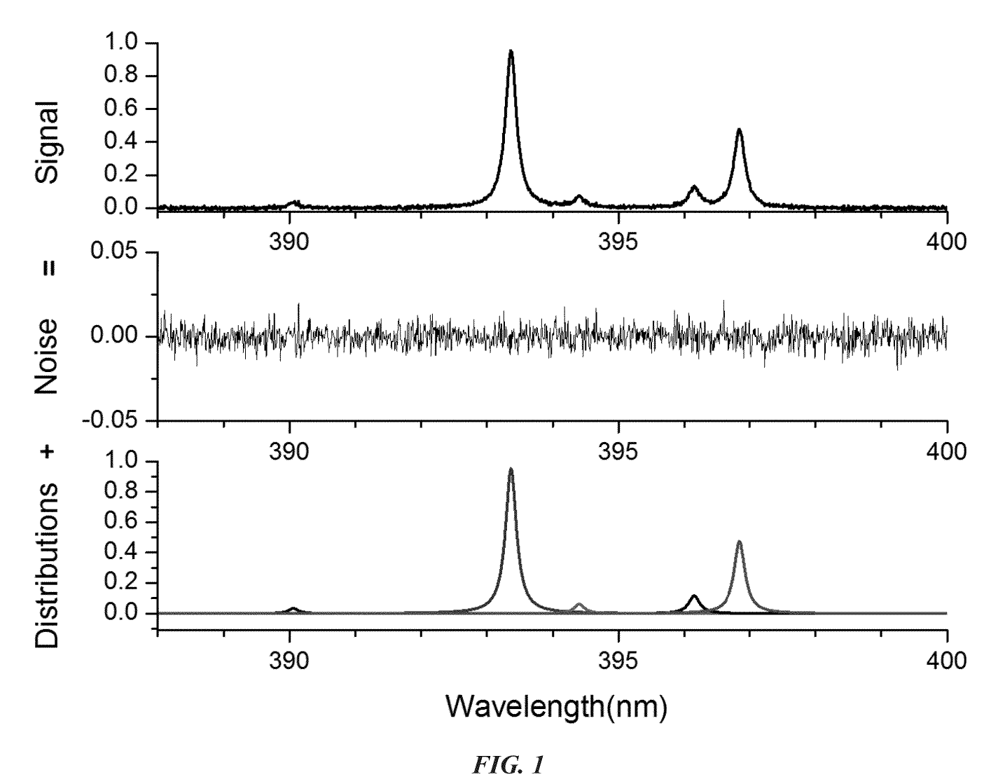

Upon receiving a spectrum (multimodal distribution over a list of emitters from a database), such as that seen in FIG. 1, individual distributions can be then extracted by fitting spectral profiles for each line. The fitted spectral lines are background free, are noise free (in order to use the spectral lines later in determining level of confidence), have minimal to no overlaps (i.e., no effective amount of overlaps), and each have a line assignment. There is no assumption regarding the resolution of the spectrometers.

The process of extracting the distribution can be seen in FIG. 1. In particular, the unprocessed spectrum includes a background that is corrected for plus noise that is extracted plus a probabilistic distribution. Thus, once the background is corrected and noise is extracted, the probabilistic distribution remains.

Each peak is attributed with a list of emitters, each of them having an emission strength, interpreting the probability of each emitter to be at the origin of that spectral line.

The correlation between spectral lines can be defined by different algorithms/models/databases giving set of spectral lines is given for each element/set of elements and a measurement of the correlation between the number of expected transitions and measured provides a ranking of the more probable elements to be at the origin of the spectrum. This can be done such as in FIG. 8 where aluminum and calcium have a large matching score compared to titanium.

Regarding fusion of multiple spectral lines, levels of confidence were sent for metallic samples to initiate the calculations (see FIG. 1), producing an array of inference that can be made. Each line j has a set of emitters i {Eᵢ^{j}} with attributed probabilities p(Eᵢ^{j}). The influence of other lines on the set of a first line is unknown, p(Eᵢ^{j}|{Eₗ^{k}}). Further, the logic maintains that if the de-excitation of the same upper level appears in two spectral lines (i.e., a spectral doublet), then the probability of this element is higher for both lines. By normalization, the other elements would have a lower probability.

The two approaches given in the previous two points can be used alone or combined in order to provide a correction factor to the score obtain for each transition during the analysis of each single spectral line.

As an example, if the emission strength is based on the population of the upper level of the transition (energy E and degeneracy g), each transition in the database is attributed the factor:

gA/Z(T).exp (−E/T)

where A is the probability of the transition, T is temperature, and Z(T) the partition function of the ion. In determining probability of population, there is a need for an effective temperature.

It is contemplated that the determination of emission strength can include more plasma parameters such as temperatures, electronic density (better representation of ions), and ion densities (possibly improving on the stoichiometric ablation). These parameters can be used as parameters and/or measured and implemented in the calculation of the emission strength.

Once this emission strength is obtained for each transition considered for a given distribution, it is multiplied by the value of the distribution for the wavelength of the transition. An example of such a list for each peak in FIG. 1 is given in FIG. XY.

The quantitative approach of certain embodiments of the current invention provides a plurality of improvements and advantages over the conventional art, in particular standard LIBS technology. Further, the present invention could consider the signal-to-noise ratio (SNR) by providing a factor representing this SNR that can be included in the calculation.

When evaluating the value for signal strength, different values or parameters were tested. Equiprobability was not representative of signal strength. Probability of emission was observed to have issues with ions, even with low temperature plasmas. Population of the upper level was observed to have large dependence and a need for a representative temperature. Thus, measurements of temperature should be performed as well.

Algorithm

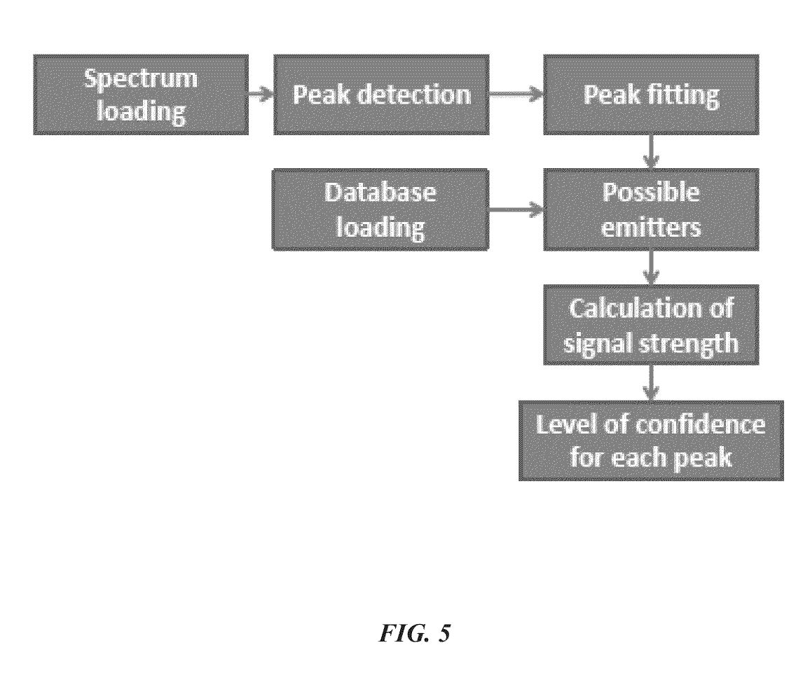

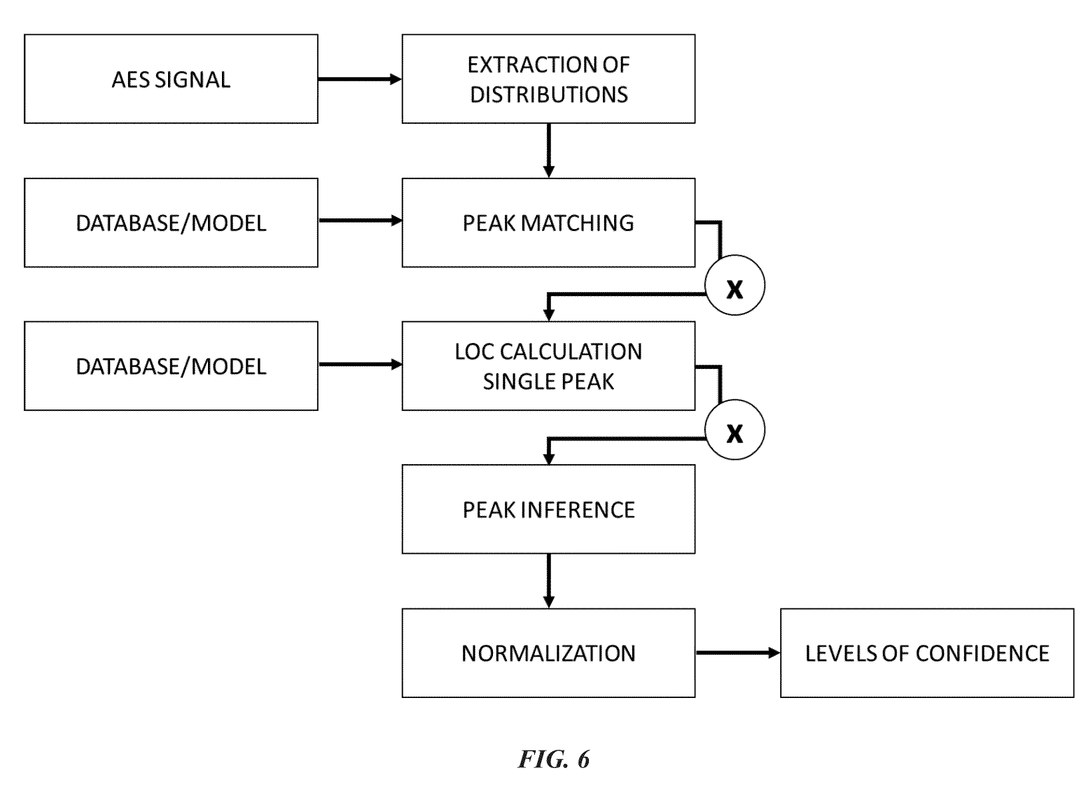

FIGS. 5-6 depict step-by-step algorithms of exemplary embodiments of the software application. As seen in FIG. 5, the spectrum is loaded from the instrument and peaks detected. The peaks are fitted to corresponding spectral tines. Possible emitters are then observed from the fitted peaks, using the database previously loaded in the software application. Upon recognition of possible emitters, the spectral lines are normalized to indicate signal strength of each emitter. Then the signal strength of the emitters are calculated, thus leading to a determination of the level of confidence of emitters for each peak.

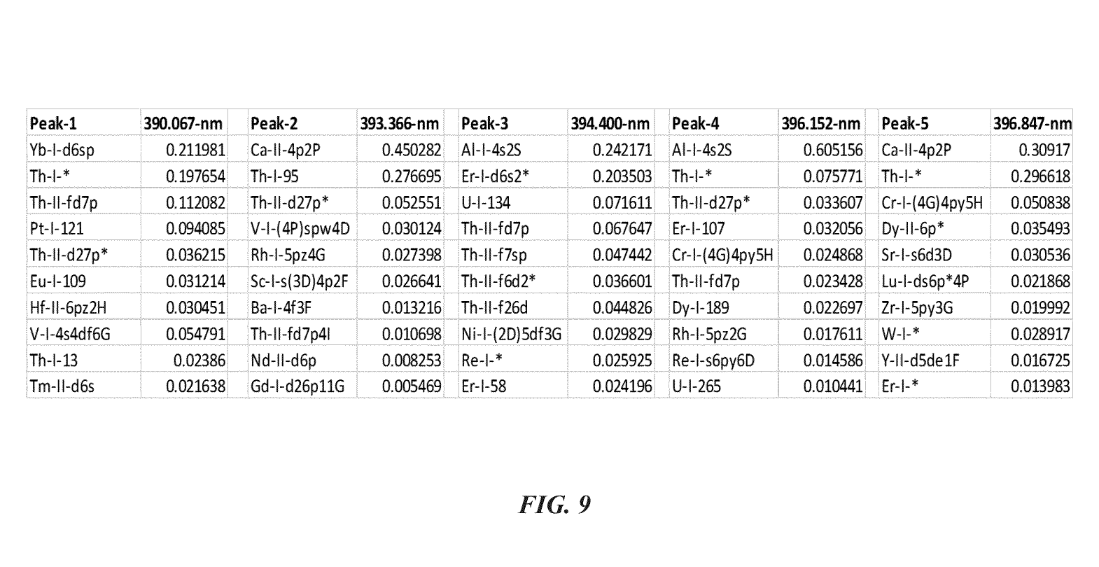

As seen in FIG. 6, a signal is received, where the signal can indicate atomic interferences and/or molecular interferences. The central position (e.g., central wavelength) for each peak in the signal can be defined, along with the width and shape of the peaks, thus providing density distributions. Once this information is obtained, the distribution for each peak is extracted. The extracted distributions are then compared to the pre-loaded model/database, where the model database provides wavelength, emission intensity, entry levels, etc. about the transitions. Emission strength is calculated for each transition that can be found in the database. Each emission strength is then multiplied by the value of the transition wavelength of the distribution (approaches zero (0) as moving further from the peak). Each transition under a spectral peak has a probability that can be normalized to have a sum of one (1) over a certain spectral range to provide a notion of probability. Normalization is defined by the number of transitions considered. This results in the level of confidence for a single peak. FIG. 9 is a chart with exemplary data for level of confidence after single peak analysis without correlation measurements. In addition to this calculation for the single peak, however, a peak matching algorithm can be used to obtain information on the correlation between peaks of each element and an algorithm can be used to merge the information of each peak (called in the figure “peak inference”) in order to refine the calculation of the level of confidence.

When studying the value for the signal strength, prior knowledge of the composition could be incorporated. Additionally, population of the upper level of the analyte should be evaluated, for example by using measurements of excitation temperature from the spectrum to verify the possibility of using the upper level population. The measurement of electronic density may go further in a plasma model (i.e., densities and temperatures).

Hardware and Software Infrastructure Examples

The present invention may be embodied on various computing platforms that perform actions responsive to software-based instructions and most particularly on touchscreen portable devices. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++, Visual Basic or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted that when referenced, an “end-user” is an operator of the software as opposed to a developer or author who modifies the underlying source code of the software. For security purposes, authentication means identifying the particular user while authorization defines what procedures and functions that user is permitted to execute.

Definition of Claim Terms

Analyte: This term is used herein to refer to any substance or composition undergoing spectral analysis. Analytes typically contain more than one elements or emitters that are to be identified and analyzed.

Emitter: This term is used herein to refer to an element in a composition that radiates energy as a result of being excited, for example by a highly energetic laser pulse.

Intensity. This term is used herein to refer to a qualitative measurement of signal strength.

Level of confidence: This term is used herein to refer to a measurement of accuracy in the assignment of a spectral line to a peak in the spectrum.

Signal strength: This term is used herein to refer to the strength of the absorption, emission, and/or scattering of radiated energy by an emitter or element in the analyte. Signal strength is typically indicated by the spectral line of the emitter.

Spectral database: This term is used herein to refer to a collection of information regarding the assignment of spectral lines to peaks.

Spectral information: This term is used herein to refer to any data relating to the identification, assignment, or analysis of a spectral peak. Examples include, but are not limited to, the position of the peak in the spectrum, the strength of the absorption/emission/scattering, and additional technical details on the physics of the transition.

Spectral line: This term is used herein to refer to the estimated value of radiated energy of an emitter or element, where the peak representing the radiated energy is assigned a corresponding spectral line based on data compiled in the spectral database (e.g., NIST).

Spectral peak: This term is used herein to refer to a measurement of the excitation of an emitter in a composition.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. One or more tangible non-transitory computer-readable media having computer-executable instructions for performing a method of running a software program on a computing device, the computing device operating under an operating system, the method including issuing instructions from the software program to automatically quantitatively determine confidence for identification of an emitter represented by a spectral peak, the instructions comprising:
receiving a spectral database containing spectral information, said spectral information including a plurality of emitters and a plurality of spectral peaks associated with said plurality of emitters;
receiving a spectrum associated with an analyte that includes said emitter;
evaluating said spectrum and detecting peaks of said analyte;
automatically assigning said peaks to corresponding spectral lines;
automatically identifying possible emitters associated with said spectral lines, said identification based on a comparison of said spectral lines to said spectral information contained in said spectral database;
normalizing said corresponding spectral lines to indicate signal strength of said possible emitters;
calculating said signal strength of said possible emitters associated with intensity of said spectral lines; and
automatically determining a level of confidence of identification of each emitter of said possible emitters.

2. A computer-implemented method of automatically quantitatively determining a level of confidence for identification of an emitter represented by a spectral peak, comprising:
receiving a spectral database containing spectral information, said spectral information including a plurality of emitters and a plurality of spectral peaks associated with said plurality of emitters;
receiving a spectrum associated with an analyte that includes said emitter;
evaluating said spectrum and detecting peaks of said analyte;
automatically assigning said peaks to corresponding spectral lines;
automatically identifying possible emitters associated with said spectral lines, said identification based on a comparison of said spectral lines to said spectral information contained in said spectral database;
normalizing said corresponding spectral lines to indicate signal strength of said possible emitters;
calculating said signal strength of said possible emitters associated with intensity of said spectral lines; and
automatically determining a level of confidence of identification of each emitter of said possible emitters.

3. One or more tangible non-transitory computer-readable media having computer-executable instructions for performing a method of running a software program on a computing device, the computing device operating under an operating system, the method including issuing instructions from the software program to automatically quantitatively determine confidence for identification of an emitter represented by a spectral peak, the instructions comprising:
receiving a model or database providing spectral information about an array of transitions;
receiving a signal indicating atomic interferences, molecular interferences, or both;
defining a central position for each peak in said signal in order to provide density distributions;
extracting a distribution of said each peak;
comparing said extracted distribution to said model or database;
calculating emission strength for each transition that can be found in said model or database;
multiplying said emission strength by a value of a wavelength of said each transition of the distribution, where said each transition under a spectral peak has a probability that can be normalized to have a sum of one (1) over a spectra range to provide a notion of probability, wherein normalization is defined by the number of transitions considered;
based on the foregoing steps, provided a level of confidence for said each peak.
